(19) United States
(12) Patent Application Publication
(10) Pub. No.: US 2011/0303854 A1
(43) Pub. Date: Dec. 15, 2011

(54) GAMMA RAY DIRECTIONALITY PROBE

(75) Inventor: Raymond DeVito, North Logan, UT (US)

(73) Assignee: UTAH STATE UNIVERSITY, North Logan, UT (US)

(21) Appl. No.: 13/159,184

(22) Filed: Jun. 13, 2011

Related U.S. Application Data
(60) Provisional application No. 61/354,323, filed on Jun. 14, 2010.

(51) Int. Cl. G01T 1/00

(52) U.S. Cl. 250/394

(57) ABSTRACT

A probe for determining direction to a radiation source emitting gamma rays with radiation detectors arranged around a scattering element. Incoming gamma rays are deflected by Compton scattering within the scattering element. Scattered radiation is detected in the radiation detectors. The detected pattern of secondary scatter into the detectors is dependent on the location of the source. The analog outputs from the processing electronics are routed from the detectors to a digital processing unit. A directional filter algorithm that combines rates at different detectors decodes the direction to the source.

### RELATED APPLICATIONS

This application claims the benefit under 35 U.S.C. §119(e) of U.S. Provisional Patent Application No. 61/354,323 filed Jun. 14, 2010, and titled “Surgical Probe” which is incorporated herein by reference.

### TECHNICAL FIELD

The present invention relates to apparatus for identifiy the direction to a radiation source. More specifically it relates to surgical probes utilizing radioactive tracers and more specifically it relates to surgical probes utilizing positron emitting tracers.

### BACKGROUND

Several situations require the identification of the direction to a source of radiation including security applications, process applications, research applications and methods involving radioactive tracers. The flux of gamma rays coming from radioactive sources provides a means to identify the direction. Herein annihilation radiation resulting from the annihilation of a positron with an electron will be considered as gamma rays.

Positron emission tomography (PET) can detect tumors early and reveal the extent to which cancer has spread. Since PET highlights cells biological activity it can visualize a tumor months before it is large enough to be detected by other imaging methods such as x-ray computed tomography. The radiopharmaceuticals for locating tumors are known and understood. Similar to the imaging procedures used in cancer localization, FDG can be used in the surgical arena to locate sites of cancer.

The pathology of the sentinel node may allow better determinations of appropriate treatments based on assessment of the extent of disease. Patients with cancer can realize clinical benefits of the application of these techniques through a more selective approach to axially lymphadenectomy. Surgical probes may be applied to colon, breast, pancreatic, gastric, ovarian and prostate cancers, pediatric neuroblastoma, neuroendocrine tumors, and abnormalities in the thyroid and parathyroid function and more. In these and other applications improved probes can provide superior diagnostic information, improve treatment outcomes and thus reduce healthcare costs.

### DESCRIPTION OF THE FIGURES

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1. Schematic cross section of probe components.

FIG. 2. Number vs. angle distribution of Compton scattered photons for 511 keV and cumulative Number vs. angle.

FIG. 3. Analytic configuration for one dimensional data.

FIG. 4. Response of electronic directional filter as a function of ε at 15° and 30° (in percent of the response at 0°) for a 3 μci source of F-18 located 3 cm in front of the probe.

FIG. 5. Signal to noise ratio of electronic directional filter as a function of ε at 0°, 15° and 30° for a 3 μci source of F-18 located 3 cm in front of the probe.

### DETAILED DESCRIPTION

In one embodiment the probe design utilizes information from multiple pixelated segments of solid state detector. The multi-channel detector configuration collects data from more than one part of the probe simultaneously. The gamma ray directionality probe described herein provides the ability to operate over the energy range from 35 to 511 keV (or higher). At low energies the probe operates with a single bore collimator or can be configured with a pinhole collimator. At high energies the signals from different parts of the detector are processed to provide electronic collimation of gamma events.

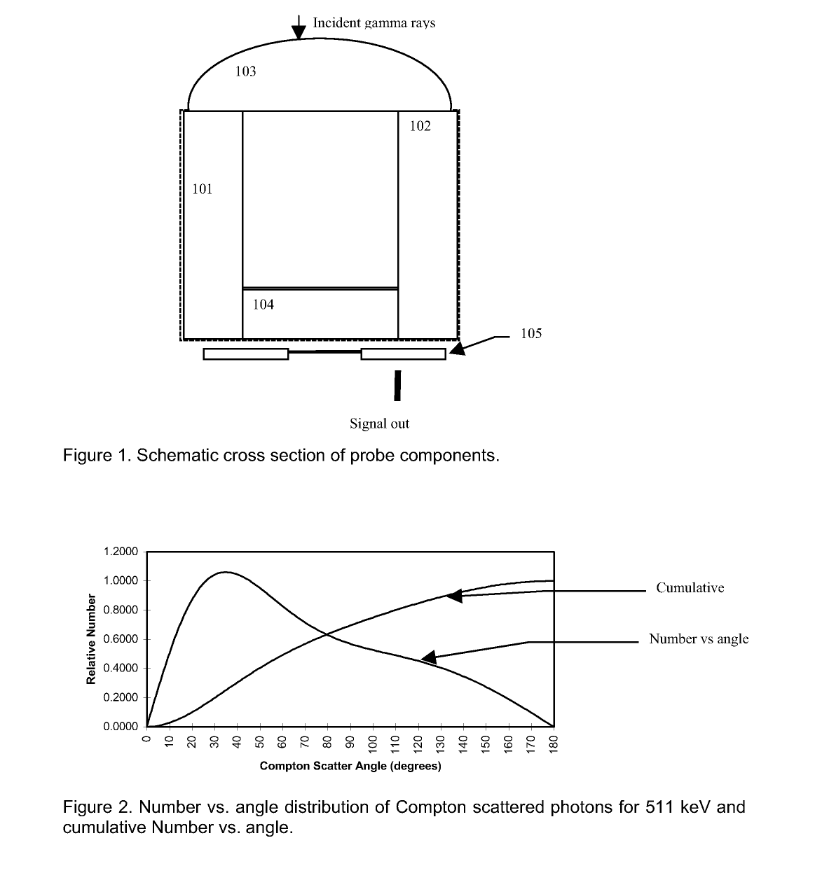

In one embodiment the probe has radiation detectors 101, 102 arranged within the tip of the probe as shown in FIG. 1. For high energy gamma emissions (e.g. 511 keV) the collimator is removed. Each segment is preferably, but not necessarily made of CZT, pixelated to provide energy and spatial information across the detector segment. Alternative detector configurations and detector materials can be used as well. In one embodiment the detectors are arranged in a barrel-like configuration. Incident material 103 covering the front of the probe is preferably high electron density but relatively low atomic number. This allows Compton scattering without much photoelectric absorption. The principal interaction in the front surface of the detector is Compton interaction. Compton scattering for 511 keV is forward peaked (see FIG. 2) with precisely defined kinematics. The detected pattern (spatial and energy) of secondary scatter into the lower barrel of the detector is thus dependent on the location of the source. In another embodiment four or more detectors are positioned around the perimeter of the (square) barrel. In another embodiment another detector 104 is configured on the bottom of the barrel. The analog outputs from the processing electronics are routed from the detector to an external ADC and a digital processing unit. In one embodiment the processing electronics are ASIC electronics 105. Count rates from probes are not very large, common central processing units are expected to be adequate for control and real time processing of events. If high count rate applications are necessary, a contingency option would be to use fast DSPs for real time processing. A directional filter algorithm that combines rates at different pixels and different energy windows provides a measure of the activity in the forward direction (or another or multiple selected viewing direction(s) for the probe). The well defined directional information in the patterns of Compton scattering for a known energy provide the means to sample according to the direction of the source. The barrel geometry provides a favorable geometry to collect the Compton scattered photons.

Many forms of the directional filter algorithm are possible. Those skilled in the art will devise multiple methods to account for the difference in count rates among the detectors (e.g. 101, 102) that is correlated to the direction of the radiation source. All such directional filters are herein considered as various embodiments of the instant invention. For example algorithms can rely on difference in count rates between detectors, ratios of count rates between detectors, count rates between detectors normalized by sums of count rates, ratios of count rates between detectors normalized by sums of count rates, more complex algebraic expressions capturing the difference in count rates, neural networks trained for this application and others. One such algorithm is herein described in detail.

For low energy applications the probe can be configured with a standard single bore collimator, providing performance equivalent to current commercial probes. For high energy gamma rays and beta emitters the probe has a scattering medium and no collimator and uses an electronic directional algorithm.

Collimators for high energy photons (e.g. 511 keV) are bulky and inefficient. For detectors like Csl, Nal and CZT (even LSO), the principal interaction with the detector is Compton scattering. The novel barrel configuration employed by our probe provides a favorable geometry to collect the Compton scattered photons. The Compton scattering interaction process carries directional information and produces a distinctive spatial and energy pattern in the detector that is dependent on source location and used to provide electronic collimation for the probe. A combination of rates of different pixels and energy windows provides a measure of activity in a given direction. The Compton scattering patterns provide means to determine the direction to the source.

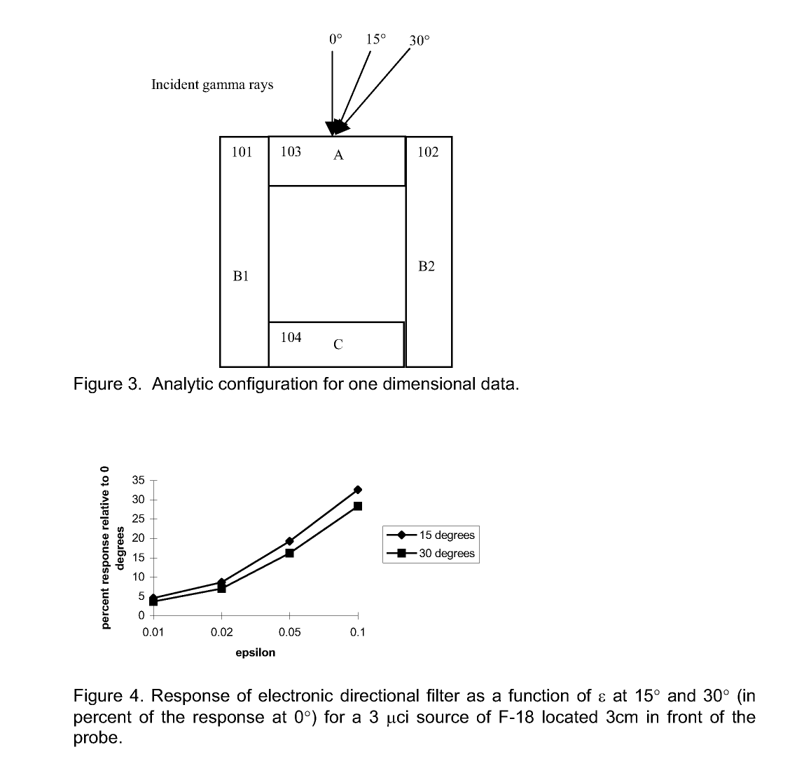

In one embodiment, an example heuristic directional filter algorithm for the electronically collimated probe is formulated. The average flux and energy for each of the B detectors 101, 102 and the base detector C 104 for three positions of a point source of 511 keV photons (see FIG. 3) is calculated. Only initial interactions in the top layer A 103 are considered (we ignore direct penetration through A 103 and subsequent interaction in B 101, 102 or C 104). Klein-Nishina cross sections are computed along with the absorption fractions for each section. Finally a relative rate for each detector and source position is derived. No energy windows are used in this one dimensional analysis. Table 2 presents this preliminary response data.

TABLE 2
Preliminary electronic collimation data (computed)

| Source | | | | | Computed |
|---|---|---|---|---|---|
| position | A | B1 | B2 | C | Rate |
| 0° | 22.7 | 1.9 | 1.9 | 1.0 | 100 |
| 15° | 23.4 | 2.5 | 2.0 | 1.25 | 4.6 |
| 30° | 26.1 | 2.1 | 1.9 | 2.0 | 3.7 |

As the source moves from 0 degrees there is a mismatch among the elements of 101 and 102. (As the source goes off center there is a compensation effect on B2 side 102, i.e. as the angular distribution changes, the energy changes, the absorption coefficient changes and the effective depth change to compensate and make a flat response.) A preliminary heuristic algorithm is modeled to reflect that off center contributions create mismatches in the elements of section B 101 and 102 and that as the source moves off center the relative strength of section C 104 increases:

Count rate at 0°=N₀×A[|B1−B2|/(B1+B2)+|C−0.044A|/(C+0.044A)+ε]⁻¹

where ε is an adjustable sensitivity parameter. For the computation in Table 2, N₀ gives a normalization to 100 and ε=0.01.

At 0° the symmetry of the probe leads B1 101 and B2 102 to be equal. The rate value for detector C 104 becomes lowest at 0° as the lower intensity and more penetrating forward scattering is directed towards it. This algorithm gives the count rate values shown as “Computed Rate” in Table 2. This electronically collimated system produces a reduction by a factor of 22 for 15° off center and parameter ε=0.01. The algorithm is linear with respect to source strength and monotonic with respect to source depth. Monotonic response is important for locating a source. If necessary the value of N₀ can be made dependent on detector response parameters to calibrate the response to match a traditional collimator.

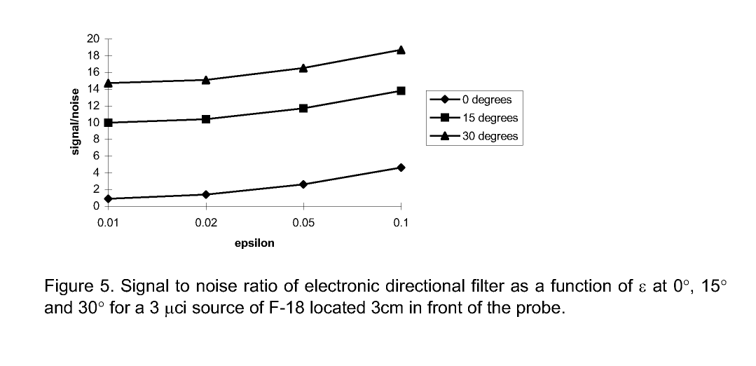

The parameter ε functions as a resolution and sensitivity adjustment. Adjusting ε to smaller values makes the electronic directional filter relatively more sensitive to the forward (0°) direction (better spatial resolution). However, the signal-to-noise ratio of the electronic directional filter also decreases as ε decreases. This effect is analogous to changing physical collimators; as the collimator becomes more restrictive, the resolution becomes better but the count rate decreases and the signal-to-noise ratio decreases. Thus by adjusting ε we can alter the resolution to sensitivity trade-off at will, without the need to change collimators (this can be especially advantageous during a surgical procedure). FIG. 4 shows a plot of the response of the electronic directional filter as a function of ε at 15° and 30° (in percent of the response at 0°) for a 3 μci source of F-18 located 3 cm in front of the probe. FIG. 5 shows a plot of the signal-to-noise ration as a function of ε for the same source strength and position.

The signal to noise properties of the electronic directional filter are satisfactory for the 15° and 30° examples. At zero degrees, the algorithm is more sensitive to noise. For the 3 μci source example a value of epsilon larger than 0.04 would need to be used to bring the signal-to-noise ration greater than 2.

The final algorithm is extended to two dimensions and could include sampling through energy windows and by pixels. If the primary scattering element 103 is replaced by a detector then Compton events can be identified by the coincidence of the multiple interactions in the probe. Selection can be made of “true” Compton events by requiring this coincidence. Assembling data for electronic directional filtering may use the coincidence requirement to separate penetrating singles from the Compton data.

Data rates must be high enough to support the signal to noise characteristics of the directional filter. The above analytic calculation gives interaction percentages of incident events of Compton channels. For a 3 μci source located 3 cm from the probe there are 4400 Compton events per second. This data rate is sufficient to produce useable directional information with response times less than 1 sec.

Feedback to the operator will be by audio, essentially using the same methods employed today in single bore collimator surgical probes. Audio feedback will send a tone indicating the count rate (physically collimated or electronically collimated) at zero degrees. Further information (beyond that available from single bore collimator surgical probes) will be available from this probe. A visual display or computer graphics will be able to display additional information regarding off central axis source strength and other factors.

Additional embodiments include other computational techniques to provide source directional information to the user. Some examples are, but are not limited to, looking at differences between segment count rate, ratios between segment count rates and other combinations characteristic of the mismatch in count rate caused by the directional nature to the Compton scattering.

The above description discloses the invention including preferred embodiments thereof. The examples and embodiments disclosed herein are to be construed as merely illustrative and not a limitation of the scope of the present invention in any way. It will be obvious to those having skill in the art that many changes may be made to the details of the above-described embodiments without departing from the underlying principles of the invention.

What is claimed is:

1. An apparatus for determining direction to a source of gamma rays comprising:
a first gamma-ray detector;
a second gamma-ray detector;
a scatter element;
said first gamma-ray detector positioned approximately parallel to said second gamma-ray detector;
said scatter element positioned between said first detector and said second detector;
wherein said first detector has processing electronics to measure and output gamma ray interaction count rate in said first detector; and
wherein said second detector has processing electronics to measure and output gamma ray interaction count rate in said second detector.

2. An apparatus as in claim 1 further comprising:
shielding material surrounding said first and second gamma-ray detectors wherein said shielding material in effective at absorbing gamma rays.

3. An apparatus as in claim 1 further comprising:
a processor;
said processor receiving said count rate output from said first gamma-ray detector;
said processor receiving said count rate output from said second gamma-ray detector; and
said processor computing direction to said source of gamma rays.

4. An apparatus as in claim 3 further comprising:
a notification means to provide information on said computed source direction.

5. An apparatus as in claim 1 wherein:
said scatter element is also a gamma-ray detector.

6. An apparatus as in claim 1 further comprising:
a third gamma-ray detector;
said third gamma-ray detector positioned approximately parallel to said first gamma-ray detector and together with said first detector and said second detector is around said scatter element; and
wherein said third detector has processing electronics to measure and output gamma ray interaction count rate in said third detector.

7. An apparatus as in claim 6 further comprising:
a processor;
said processor is receiving said count rate output from said third gamma-ray detector.

8. An apparatus as in claim 7 further comprising:
a forth gamma-ray detector;
said forth gamma-ray detector positioned approximately parallel to said first gamma-ray detector and together with said first detector and said second detector and said third detector is around said scatter element; and
wherein said forth detector has processing electronics to measure and output gamma ray interaction count rate in said forth detector.

9. An apparatus as in claim 8 wherein:
said processor is receiving said count rate output from said forth gamma-ray detector.

10. An apparatus as in claim 9 wherein:
said processor is computing direction to said source of gamma rays.

11. An apparatus as in claim 10 further comprising:
a notification means to provide information on said computed source direction.

12. An apparatus as in claim 1 wherein said apparatus is used in surgery to locate a radioactive tracer.

13. An apparatus as in claim 1 further comprising:
a fifth gamma-ray detector;
said fifth gamma-ray detector positioned approximately perpendicular to said first gamma-ray detector and between said first detector and said second detector; and
wherein said fifth detector has processing electronics to measure and output gamma ray interaction count rate in said fifth detector; and
said processor is computing direction to said source of gamma rays.

14. An apparatus for determining direction to a source of gamma rays comprising:
a first position-sensitive gamma-ray detector gamma-ray detector;
a second position-sensitive gamma-ray detector gamma-ray detector;
a scatter element;
a processor;
said first position-sensitive gamma-ray detector positioned approximately parallel to said second position-sensitive gamma-ray detector;
said scatter element positioned between said first position-sensitive detector and said second position-sensitive detector;
wherein said first position-sensitive detector has processing electronics to measure and output position dependent gamma ray interaction count rate in said first position-sensitive detector; and
wherein said second position-sensitive detector has processing electronics to measure and output position dependent gamma ray interaction count rate in said second position-sensitive detector
said processor is receiving said count rate output from said detectors.

15. An apparatus as in claim 14 further comprising:
a shielding body surrounding said first and second position-sensitive gamma-ray detectors.

16. An apparatus as in claim 14 wherein:
said scatter element is also a gamma-ray detector.

17. An apparatus as in claim 14 wherein:
said processor is receiving said count rate output from said position-sensitive gamma-ray detectors.

18. An apparatus as in claim 17 wherein:
said processor is computing direction to said source of gamma rays.

19. An apparatus as in claim 18 further comprising:
a notification means to provide feedback to the operator on source direction.

20. An apparatus as in claim 14 wherein said apparatus is used in surgery to locate a radioactive tracer.
